(19) United States
(12) Patent Application Publication
(10) Pub. No.: US 2002/0060120 A1
(43) Pub. Date: May 23, 2002

(54) Support for a motion sensor of coins supplied by the hopper of a recreational machine

(75) Inventor: Jesus Franco Munoz, Madrid (ES)

Correspondence Address: OSTROLENK FABER GERB & SOFFEN, 1180 AVENUE OF THE AMERICAS, NEW YORK, NY, 100368403

(73) Assignee: Proindumar, S.L.

(21) Appl. No.: 09/771,177

(22) Filed: Jan. 26, 2001

(30) Foreign Application Priority Data
Nov. 2, 2000 (ES) P 200002637

(51) Int. Cl. G07D 1/00

(52) U.S. Cl. 194/215; 194/302

(57) ABSTRACT

Especially designed as an opto-electronic sensor, as an addition to the classic electromechanical sensor available in games machine dispensers (2) awarding prizes in cash, consisting of a pair of bent plates (11) jointly fixed to the entrance door (6) of the machine door (7), specifically framing the slot (5) in the entrance door (6), for the transport of coins from the dispenser (2) to the applicable prize-collecting tray (6), so that the parallel branches of these plates (10-10′) support the photoemitter (15) and photoreceptor (16) respectively in this opto-electronic sensor, interconnected through orifices (17) in the plates themselves (10-10′) and in the orifices (18) that are operated at the front of the dispenser (2), framing the exit coin mouth (4), so that this luminous beam is interrupted during coin movement to apply the necessary detection and accounting.

### SUMMARY

Especially conceived for an electronic eye sensor, complementary of the classical electromechanical sensor contained in the hoppers (2) of recreational machines which dispense cash prizes, consisting of a pair of angular brackets (11) which attach solidly to the inner door panel (6) of the machine's door (7), specifically surrounding the groove (5) that exists on said inner door panel (6) for the coins to pass from the hopper (2) to the corresponding collection tray (8), in order that the parallel flanges of said pieces (10-10′) respectively support the photo-emitter (15) and the photo-receptor (16) of said electronic-eye sensor, communicated with each other by means of openings (17) on the brackets (10-10′) themselves and of openings (18) made in the front area of the hopper (2), surrounding the coin outlet (4), so that said ray of light is interrupted when each coin passes through in order to attain the required detection and consequent counting.

### OBJECT OF THE INVENTION

The present invention refers to a support that has been especially designed to support a coin motion sensor, at the exit of the payer, or hopper, of a recreational machine, in order to correctly count the corresponding coins, for example a prize supplied by the machine.

The object of the invention is to allow the physical independence of the coin motion sensor from the hopper, in order that there is no dependence between these elements from the manufacturing standpoint.

### BACKGROUND OF THE INVENTION

Within the range of recreational machines there are machines that supply cash prizes to the player, that is, coins of legal tender, for which they use a hopper, which consists of a coin storage with means to supply said coins unitarily and to conveniently count them.

The most usual solution consists in materializing said hopper into a receptacle which tends to be of cylindrical configuration at an affectedly inclined axis, on the bottom of which there is a drum for the drawing of the coins, which emerge tangentially from it, establishing at the exit a rocker arm which at the passing of each coin tilts acting upon a microswitch that sends data to the governing circuit of the machine so as to count the coins that it supplies and make the number of them correspond with the prize obtained by the player, if applicable.

Aside from these electromechanical counters, widely divulged in the area of recreational machines with this or other purposes, electronic-eye sensors are also known, consisting of a photo-emitter and a photo-receptor, which generate the corresponding signal when the ray of light established between both elements is interrupted by the passing of a coin or by the passing between them of any other moveable element of the machine.

In this range of recreational machines designated as standardized, as occurs for example in the U.S., it is obligatory to use two sensors to establish a safer and more efficient control of the number of coins supplied by a hopper, to guarantee the rights of the player, in order that the payment or supply of a coin is only considered real when both of the sensors have detected that it has passed.

Regarding this it is noteworthy to mention U.S. Pat. No. 5,516,293, in which the hopper incorporates a first sensor of the rocker arm type, and immediately after it a second sensor, in this case optical, which works in combination with the first one.

More precisely, in said patent the optical sensor, aside from being arranged on the hopper itself, does so substantially distant from the exit of the hopper, which entails a problem with a double aspect:

On one hand the hopper must be conceived and structured in order to allow the implantation of the mentioned optical sensor, and thus the compliance with the previously mentioned standard results very difficult with a conventional hopper, except at the level of the hopper's manufacturer himself.

On the other hand the optical sensor remains substantially distanced from the exit of the hopper, and thus any event may occur in the trajectory of the coin between these two points, so that, in spite of having been counted, it does not finally reach the player, for example due to getting jammed in its trajectory, by tilting sideways and falling again back into the hopper's receptacle, etc., which means that in spite of there having been a double control of the coin at its exit, the results of said control, from the point of view of counting, do not coincide with reality, that is, with the coins that really have reached the prize collecting tray, and from there to the player himself.

### DESCRIPTION OF THE INVENTION

The support that the invention proposes has been conceived to resolve in a completely satisfactory way the previously expressed problems, in both of the mentioned aspects, so that on one hand the optical sensor is not located in the hopper itself, which allows the use of any conventional hopper with a single control point over the coins, and on the other hand, due to the special arrangement of said support in the context of the machine, it can be thoroughly guaranteed that the second control of the coin is performed when it does not have any other option than reaching the prize collection tray.

To accomplish this, more specifically, said support is arranged on the inner door panel of the machine, surrounding specifically the classical groove which, when facing the hopper, pours directly into the coin collection tray, so that, as previously pointed out, when the coin reaches said groove when passing through the optical sensor, its drop into the collection tray is ensured.

It is specifically contemplated that the mentioned support be materialized in two angular metal brackets which fasten by one of their flanges to the inner door panel of the machine and that consequently their other flanges are parallel to each other, with this second flange constituting the support for the photo-emitter and the photo-receptor, with their corresponding circuits.

The parallel flanges of the mentioned brackets must be spaced apart to a sufficient extent so as to allow, in a closed door situation, that the hopper's exit fits between them, which is generally of scarce width, and in said exit openings must be made, established operationally so as to allow the sensor's ray of light to pass through them in the mentioned closed door situation.

Although really these openings suppose a modification to the hopper, obviously said openings can be performed with a simple drilling machine, away from the factory, by any expert such as, for example, a maintenance mechanic for this type of machines, so that the adopted solution allows an easy and fast implantation of the sensor in a machine not having one and already in operation.

### DESCRIPTION OF THE DRAWINGS

As a complement to the description that is being made and with the object of assisting to have a better comprehension of the characteristics of the invention, according to a practical preferred embodiment of it, enclosed as an integrating part of said description are a set of drawings, wherein with an illustrative and non-limiting nature, the following has been represented:

FIG. 1 shows a partial front perspective view of a recreational machine of the type that supplies cash prizes, possessing the support for the coin motion sensor which constitutes the object of the present invention, with its door in an opened situation to clearly show said support.

FIG. 2 shows an enlarged detail of the previous figure, at the level of the elements of which the invention is centered on.

FIG. 3 shows, to conclude, a cross-sectional detail of the machine, with its door closed, at the level of the mentioned support.

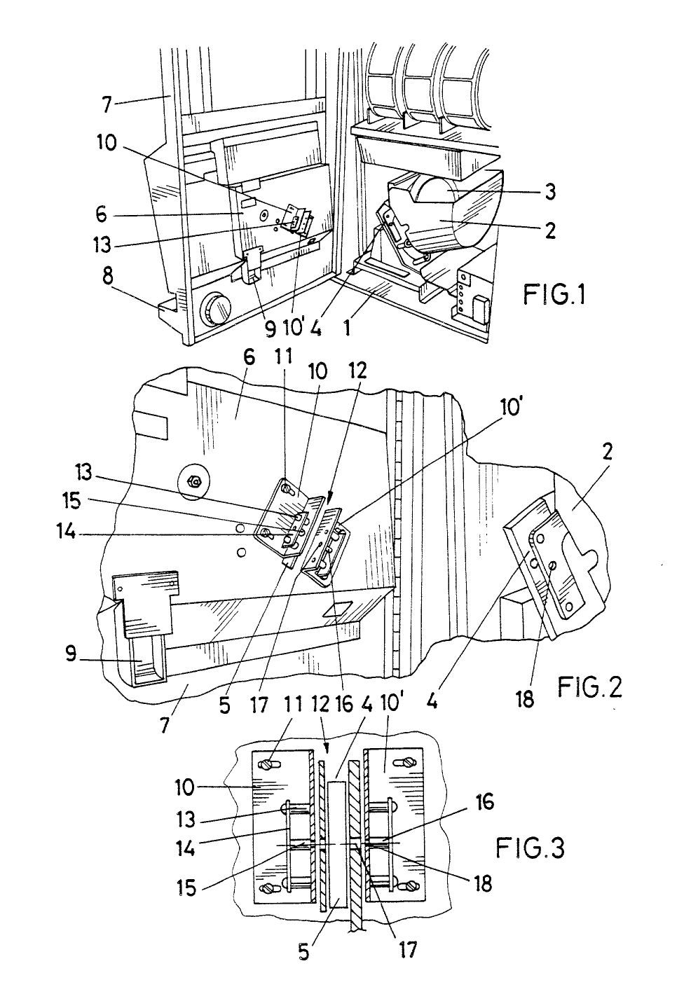

### PREFERRED EMBODIMENT OF THE INVENTION

In view of the indicated drawings it can be observed how the support being proclaimed is destined for a recreational machine in which, independently from other mechanisms that are not of present concern, there is established inside its body or frame (1) a hopper (2), on one hand acting as a coin storage and on the other hand as a means of supplying those that are to receive prizes, with the assistance of a drawing disk (3), properly motorized, which unitarily supplies the coins to an exit (4), placed frontally, specifically destined to couple with a groove (5), located operationally on the inner door panel (6) of the machine's door (7), so that from said exit (4), the coins, passing through the groove (5), fall directly and unavoidably into the prize collection tray (8).

This inner door panel (6) is usual on the doors (7) of this type of recreational machines, since it is necessary so as to accommodate in its interior different circuits of the machine, the channel (9) for inserting the coins from the corresponding selector, etc.

Thus, the support of the invention is materialized in a pair of angular brackets (10-10′), which are fastened to the back face of the inner door panel (6) for example with the collaboration of rivets (11) or any other means, surrounding the mentioned groove (5) for the passing of coins, so that while one of the flanges of said brackets (10-10′) remains perfectly fitted and attached to the inner door panel (6), the other one emerges perpendicularly from it defining a sort of channel (12) at the bottom of which is established the groove (5) and its width is adequate, in an opened door situation, for the front area of the hopper (2) in which the exit (4) of the coins is established to remain fitted into said channel.

Established in the parallel flanges of the brackets (10-10′), with the collaboration of end spacers (13), there are matching printed circuit boards (14) which together support the circuit corresponding to a conventional electronic eye sensor, the photo-emitter and photo-receptor (15-16) of which are also mounted on said boards, operatively facing respective openings (17) made in the brackets (10-10′) and which in a closed door situation face other openings (18) which are also operatively made in the walls of the exit opening (4) of the hopper (2).

In this way it is attained, according to the object of the invention, that the electronic eye sensor (14-15-16) is physically independent from the hopper (2), specifically that it remains indirectly associated with the door (7), which aside from meaning an easier accessibility for it both in operations of attaching it and also of maintenance, it allows the use of a conventional hopper (2), provided with a sensor for the counting of the coins also of the conventional type, not represented in the drawings, for example of the tilting lever type which act upon a microswitch, but establishing two controls for the exit of the coins which ensure a complete reliability in the counting of them, in that when the activation of the electronic eye sensor (14-15-16) occurs it fully guarantees the falling of the corresponding coin toward the prize collection tray (8).

1. - Support for a motion sensor of coins supplied by the hopper of a recreational machine, which being preferentially conceived to support an electronic eye sensor, complementary of the classical electromechanical sensor which the hoppers usually have, for a more efficient control of the supply of prizes, is characterized in that it consists of two angular brackets (10-10′), which are solidly fastened to the inner door panel (6) of the machine's door (7), so that in said brackets (10-10′) parallel flanges are defined which surround the classical groove (5) of the inner door panel (6) for the passing of the coins from the exit (4) of the hopper (2) toward the prize collection tray (8) located in the lower part of the machine's door (7), having contemplated that said parallel angular flanges (10-10′) constitute the support itself for the electronic eye sensor, and that its distance is such that, in a closed situation, between them fits the marginal area of the hopper (2) in which is established the opening exit (4) for the coins.

2. - Support for a motion sensor of coins supplied by the hopper of a recreational machine, according to claim 1, characterized in that each angular bracket (10-10′) incorporates in one of its flanges means (11) for attaching to the inner door panel (6) and in its other flange a pair of spacers (13) to attach to each one of them a printed circuit board (14), in order that both printed circuit boards (14) are bearers of the corresponding circuit of the electronic eye sensor, one of them of the photo-emitter (15) and the other of the photo-receptor (16).

3. - Support for a motion sensor of coins supplied by the hopper of a recreational machine, according to the previous claims, characterized in that the parallel flanges of the angular brackets (10-10′) incorporate matching openings (17), facing each other and facing both the photo-emitter (15) and the photo-receptor (16), also having contemplated that the hopper (2) incorporates, in the walls determining its exit opening (4) for the coins, respective openings (18) at the same time coaxially facing the previous ones.
